(19) United States
(12) Patent Application Publication
(10) Pub. No.: US 2012/0201052 A1
(43) Pub. Date: Aug. 9, 2012

(54) Measurement transducer

(75) Inventor: Bjorn Haase, Stuttgart (DE)

(73) Assignee: Endress + Hauser Conducta Gesellschaft fur Mess- und Regeltechnik mbH + Co. KG, Gerlingen (DE)

(21) Appl. No.: 13/501,262

(22) PCT Filed: Aug. 27, 2010
(86) PCT No.: PCT/EP2010/062521

§ 371 Date: Apr. 11, 2012

(30) Foreign Application Priority Data
Oct. 14, 2009 (DE) 10 20206 045 689.

(51) Int. Cl. H02M 3/335

(52) U.S. Cl. 363/16

(57) ABSTRACT

A measurement transmitter connectable galvanically isolated relative to one another and the other components of the measurement transmitter, which is optimized as regards installation space and number of components required for galvanic isolations. A power supply, which has a direct voltage generator, which serves to produce a stable direct voltage; a chopper, which is connected to the direct voltage generator and which produces a rectangular, alternating voltage from the stable direct voltage; a digital unit, which serves to operate the chopper; and two or more connector modules connected, in parallel with one another, to the chopper; each connector module has a transformer, which transforms the rectangular, alternating voltage; each connector module has a rectifier downstream from the respective transformer; and the rectifier produces a direct voltage from the transformed rectangular, alternating voltage. Each unit is connectable to a respective one of the connector modules and is supplied, galvanically isolated from all other components of the measurement transmitter, with the direct voltage via its connector module.

The invention relates to a measurement transmitter, including: A power supply, which is connectable to an external energy supply and which has a direct voltage generator to produce a stable direct voltage; a digital unit; and two or more connector modules, to which, in each case, a unit is connectable, especially a sensor, a measured value output or a communication unit for connecting the measurement transmitter to a superordinated unit, which connectable unit, in each case galvanically isolated from all other components of the measurement transmitter and all other units connected thereto, is supplied via the measurement transmitter with a direct voltage.

Measurement transmitters are applied in all areas of industrial measurements technology. They typically serve to convert one or more physical variables measured by the sensors connected thereto into electrical output signals reflecting the measured variables and to transmit these electrical output signals to a superordinated unit, e.g. a process control system, via an output unit, e.g. a current output, or a communication unit, e.g. a bus interface.

It is regularly required today for the industrial use of such measurement transmitter, for safety reasons, that the individual units be galvanically isolated from one another and from the energy supply of the measurement transmitter.

For this, a number of galvanic isolations corresponding to the number of units of the respective measurement transmitters are regularly required. Each of these galvanic isolations is typically a power supply 1C provided in the respective connector module; each galvanically isolated unit is supplied with energy via the power supply IC. Each power supply IC is fed direct voltage and has a switching controller on its primary side; the switching controller serves to convert the direct voltage into an alternating voltage, which is then transmitted galvanically isolated via a transformer to the secondary side, where the transformed alternating voltage is converted into the direct voltage required to supply the respective unit. Additionally, for the stabilization of the direct voltage available to the secondary side of the unit, feedback loops galvanically isolated from the secondary side are frequently provided on the primary side; based on the feedback, the primary side voltage is correspondingly regulated.

Relatively many of these galvanic isolations must especially be provided in the case of measurement transmitting for multi-sensor systems with many sensors and different communication and output units to be connected thereto. The number of the components and space required in the measurement transmitter is correspondingly high.

It is an object of the invention to provide a measurement transmitter, to which two or more units supplied with direct voltage by the measurement transmitter are galvanically isolatedly connectable relative to one another and the other components of the measurement transmitter and which is optimized as regards installation space and number of components required for galvanic isolation.

For this, the invention resides in a measurement transmitter comprising:
A power supply,
   which has a direct voltage generator, which serves to produce a stable direct voltage;
a chopper connected to the direct voltage generator,
   which produces a rectangular, alternating voltage from the stable direct voltage;
a digital unit, which serves to operate the chopper; and
two or more connector modules connected, in parallel with one another, to the chopper;
   wherein each connector module has a transformer, which transforms the rectangular alternating voltage;
   wherein each connector module has a rectifier downstream from the respective transformer; the rectifier produces a direct voltage from the transformed rectangular alternating voltage; and
   wherein a connectable unit is connectable to each connector module,
   wherein each connectable unit is supplied, galvanically isolated from all other components of the measurement transmitter, with direct voltage via its connector module.

In an embodiment of the invention, the connectable units are sensors, electrical current outputs of the measurement transmitter, and/or communication units for connecting the measurement transmitter to a superordinated unit.

In an additional embodiment, at least one of the connectable units is connected to the digital unit via a digital data line equipped with galvanic isolation. In such case, the galvanic isolation is e.g. an optocoupler or a transformer and is preferably arranged, in each case, in the associated connector module, to which the particular connectable unit is to be connected.

In a further development, the invention comprises a measurement transmitter of the invention, in which
the chopper has a p-conductive field effect transistor connected to the direct voltage generated by the voltage generator and, in series with the p-conductive field effect transistor, an n-conductive field effect transistor connected to ground;
the two field effect transistors are operated by control voltages of predetermined clock rates supplied via their control inputs in such a manner that, at a frequency predetermined by the clock rates, one of the two field effect transistors is alternately switched to conduct, while the other blocks; and
a rectangular, alternating voltage is removable via a tap arranged between the two field effect transistors.

In an additional development of the further development
the digital unit produces a first and a second, rectangular, control voltage varying with a predetermined clock rate;
the two control voltages are offset in time by a half period relative to one another;
the chopper includes a level shifter, which, based on the first control voltage, produces a rectangular control voltage with higher voltage levels and varying synchronously with the first control voltage; wherein this rectangular control voltage with higher voltage levels is applied to the control input of the p-conductive field effect transistor and the p-conducting field effect transistor is controlled thereby; and
the second control voltage lies on the control input of the n-conductive field effect transistor and the n-conducting field effect transistor is controlled via the second control voltage.

In an additional development of the further development, a dead time is provided between the individual switching procedures of the field effect transistors; the two field effect transistors are non-conductive during the dead time.

In an additional development of the development with the dead time,
the chopper includes two diodes connected in series and operated in reverse bias; the diodes are arranged parallel to the two field effect transistors and are located downstream from such;
the tap between the two field effect transistors is connected to a tap arranged between the two diodes; and
a rectangular, alternating voltage is removable from the tap arranged between the two diodes.

In an additional development of the further development, the chopper includes a disturbance suppression circuit on its input side and/or output side; the disturbance suppression circuit attenuates high frequency current fractions, especially current fractions with frequencies in the megahertz range, caused by switching events of the field effect transistors in the chopper.

In a further development, the chopper includes a direct voltage decoupling on its output side; the direct voltage decoupling eliminates a direct voltage fraction contained in the alternating voltage generated in the chopper.

In an additional further development, the alternating voltage produced by the chopper has a frequency of less than 100 kHz, especially less than 50 kHz.

In a preferred embodiment the rectifier is a bridge rectifier with a smoothing capacitor connected downstream.

The measurement transmitter of the invention offers the advantage that the alternating voltage required for the galvanic isolation of the energy supply of all connected units is centrally produced by a single chopper and is available in parallel for all isolations.

The invention and other advantages will now be explained in greater detail based on the drawing, in which an example of an embodiment is presented. Equal elements are provided with equal reference characters in the figures. The figures of the drawing show as follows:

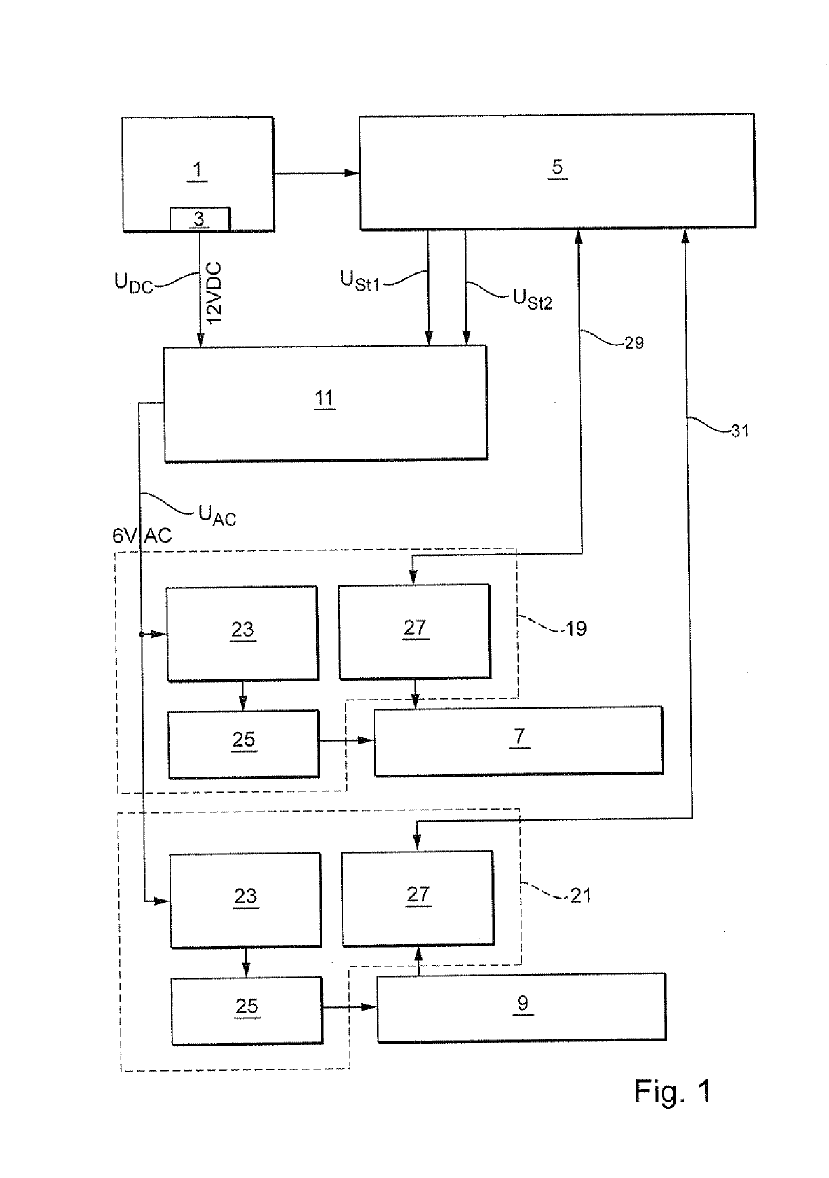

FIG. 1 a block diagram of a measurement transmitter of the invention;

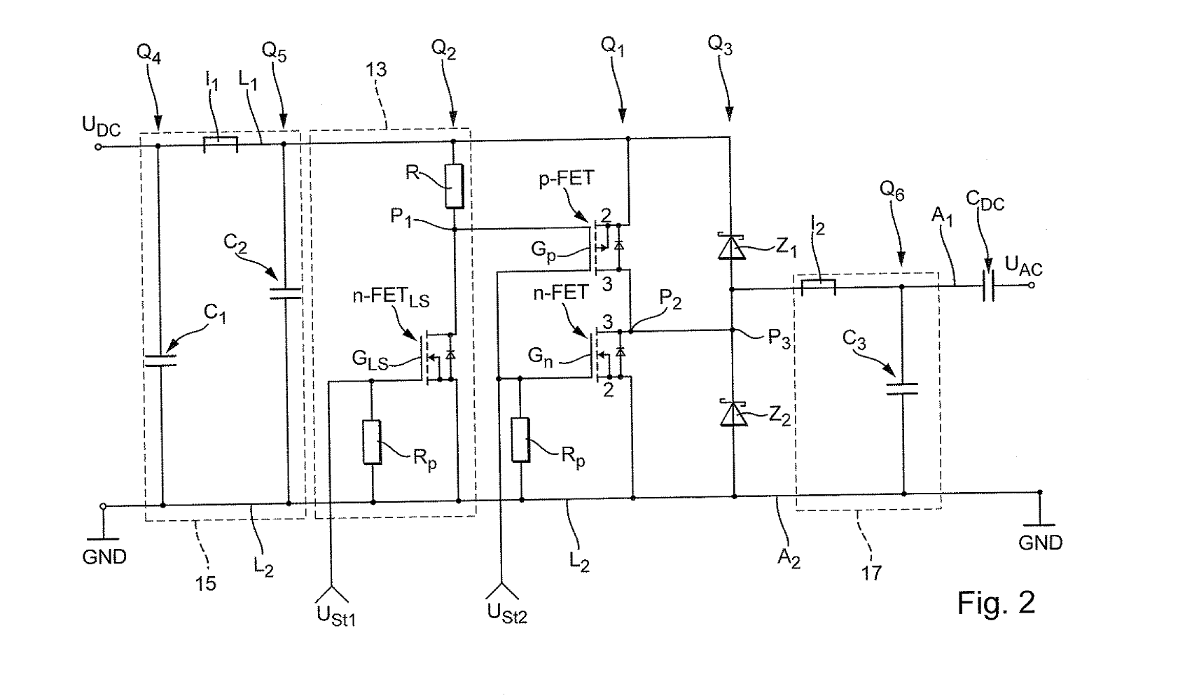

FIG. 2 a block circuit diagram of the chopper of FIG. 1;

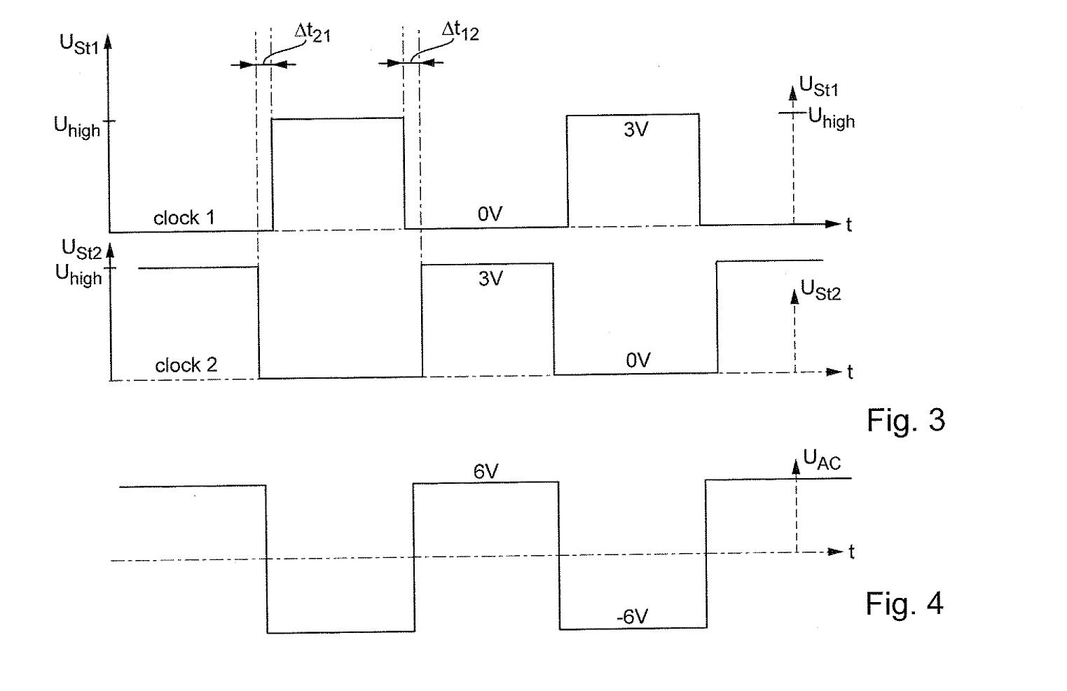

FIG. 3 control voltages generated by the digital unit as a function of time for operating the chopper;

FIG. 4 a rectangular, alternating voltage generated by the chopper; and

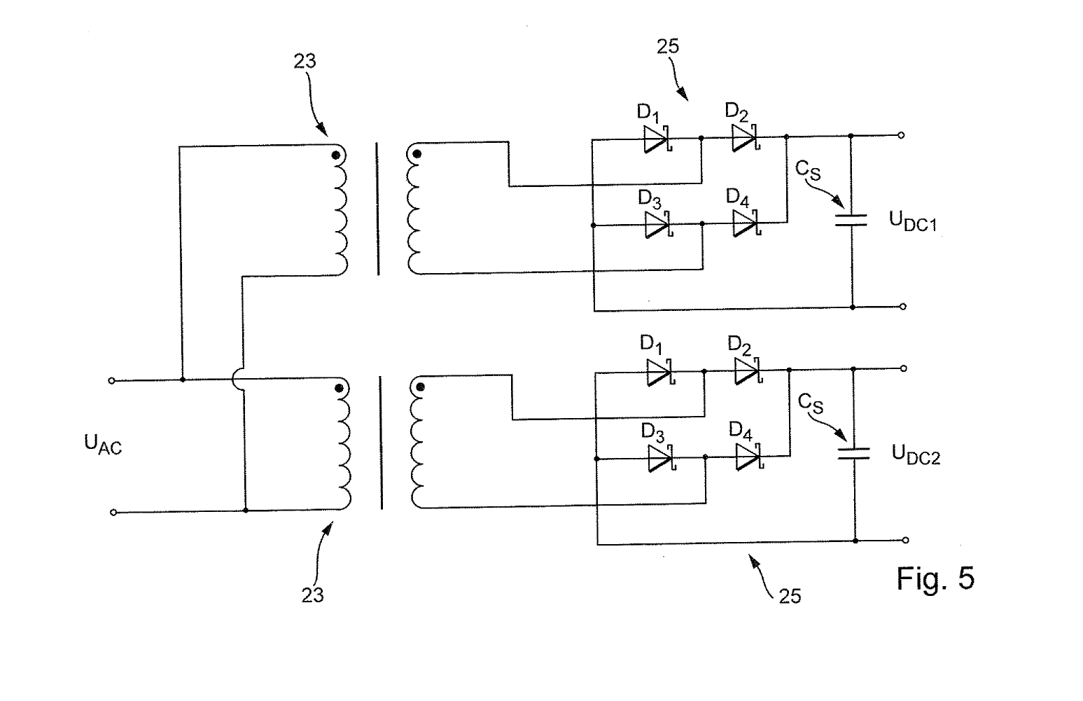

FIG. 5 two parallel transformers connected to the alternating voltage, with rectifiers connected downstream.

FIG. 1 shows a block diagram of a measurement transmitter of the invention. It includes, as with conventional measurement transmitters: A power supply 1 connectable to an external energy supply (not shown) and equipped with a direct voltage generator 3 to produce a stable direct voltage U_{DC}; and a central digital unit 5. Depending on application, two or more separate units 7, 9 are connectable to the measurement transmitter.

Units 7, 9 are sensors, electrical current outputs of the measurement transmitter, and/or communication units for connecting the measurement transmitter to a superordinated unit (not shown), such as e.g. a process control system or a programmable logic controller. For a better overview, units 7, 9 are here divided corresponding to their function into units 7 for measured value registration and units 9 for measured value output.

Units 7 for measured value registration include, especially, sensors connected to the measurement transmitter. The sensors are preferably digital sensors, which serve to measure a physical measured variable, e.g. pH value, conductivity, or oxygen concentration at their location of use, and to supply the physical measured variable to central digital unit 5 in the form of a digital measurement signal. Central digital unit 5 processes the incoming measurement signals and makes them available in an appropriately conditioned form to unit 9, which is suitable for their output. Unit 9 for measured value output is, for example, an electrical current output, which varies an electrical current flowing through a 2-wire line connected thereto as a function of the value of the measured physical variable corresponding to a usual industry standard, e.g. between 4 mA and 20 mA. Likewise unit 9 can be a communication unit for connecting the measurement transmitter to a superordinated unit (not shown), such as e.g. a process control system or a programmable logic controller. Examples of unit 9 thus include e.g. bus adapters for known fieldbus systems, such as e.g. Ethernet, ModBus, Profibus, Foundation Fieldbus, or WLAN, as well as communication modules working according to industrial standards, such as e.g. the HART standard.

In FIG. 1, two units 7, 9 are presented by way of example. The measurement transmitter of the invention is, of course, completely analogously expandable to a far greater number of connectable units 7, 9.

Digital unit 5 is, for example, a digital circuit, a microcontroller (μC) or a field programmable gate array (FPGA).

Voltage generator 3 produces a stable direct voltage U_{DC}, e.g. 12 V DC, and serves as the energy supply for the total measurement transmitter, including digital unit 5, as well as all units 7, 9 connected thereto.

According to the invention, the measurement transmitter includes a single, centrally arranged chopper 11 connected to voltage generator 3 for the galvanic isolation of all units 7, 9 relative to one another and from the energy supply; chopper 11 is fed the stable direct voltage U_{DC} by voltage generator 3, and produces therefrom a stable rectangular, alternating voltage U_{AC} with precise stabilized voltage levels, e.g. +/−6 V. In such case, chopper 11—as subsequently explained in detail—is operated by digital unit 5, which produces the required control voltages Uₛₜ₁, Uₛₜ₂ having a predetermined clocking rates clock₁, clock₂. This functionality is present as a rule in any event in digital units 5 as they are applied today in measurement transmitters, so that no additional components are required, which would otherwise require additional space in the measurement transmitter and would increase the manufacturing costs.

FIG. 2 shows a preferred example of an embodiment of chopper 11. On the input side, chopper 11 includes a first line L1 lying at the direct voltage U_{DC} and a second line L2 connected to ground GND or to a reference potential. Core elements of chopper 11 are a p-conducting field effect transistor p-FET connected to the direct voltage U_{DC} and an n-conducting field effect transistor n-FET connected to ground GND. The two field effect transistors p-FET and n-FET are arranged in series in a first transverse branch Q1 connecting first line L1 to second line L2, and are operated in such a manner via control voltages supplied to their control inputs Gp, Gn that alternately one of the two field effect transistors, p-FET or n-FET, is caused to conduct, while the other n-FET or p-FET blocks. The control voltages are accordingly rectangular, alternating voltages of a predetermined frequency f.

Chopper 11 is operated by digital unit 5, which produces two control voltages Uₛₜ₁, Uₛₜ₂ having the respective predetermined clocking rates clock₁, clock₂. Both clock rates clock₁, clock₂ have the frequency f desired for generating the alternating voltage U_{AC}.

With digital units 5 usually installed in measurement transmitters today, control voltages with a maximal voltage level U_{high} on the order of magnitude of 3 volts can be produced. This is sufficient to switch the n-conductive field effect transistor n-FET connected to ground GND directly via control voltage Uₛₜ₂ generatedby digital unit 5.

Correspondingly, control input Gₙ of this field effect transistor n-FET, as shown in FIG. 2, is connected directly to the second control voltage Uₛₜ₂ generated by digital unit 5 via a parallel resistor Rₚ connected to second line L2.

In contrast, for control of the p-conductive field effect transistor p-FET connected to direct voltage U_{DC}, essentially higher voltage levels are required depending on the value of direct voltage U_{DC}. With a direct voltage Uₘ of 12 V and a switching interval of 3 V, control voltage levels of between 9 V and 12 V are required.

In order to produce these higher control voltage levels a level shifter 13 is applied, which, based on control voltage Uₛₜ₁ generated by digital unit 5, generates a control voltage with correspondingly increased voltage levels.

Level shifter 13 comprises, for example, an additional transverse branch Q2 connected to transverse branch Q1; a resistor R and a further n-conducting field effect transistor n-FET_{LS} are arranged in series in transverse branch Q2.

This other n-conducting field effect transistor n-FET_{LS}, exactly as n-conducting field effect transistor n-FET arranged in the first transverse branch Q1, is connected to ground and includes a control input G_{LS}, which is connected to control voltage Uₛₜ₁ generated by digital unit 3 via a parallel resistor Rₚ connected to second line L2.

The control input Gₚ of field effect transistor p-FET connected to direct voltage U_{DC} arranged in the first transverse branch Q1 is connected to a tap P1 provided in the second transverse branch Q2 between resistor R and the additional n-conductive field effect transistor FET_{LS}.

Accordingly, control input Gp of p-conductive field effect transistor p-FET lies on the voltage level of direct voltage U_{DC} while the other n-conducting field effect transistor n-FET_{LS} is non-conducting. In this state, p-conducting field effect transistor p-FET is non-conducting.

If the other n-conducting field effect transistor n-FET_{LS} is made to conduct, a lower voltage level lies at tap P1 and therewith at control input Gp of p-conductive field effect transistor p-FET. The value of this voltage level is adjustable via the value of resistor R. This is selected corresponding to the switching interval of p-conductive field effect transistor p-FET in such a manner that the p-conducting field effect transistor p-FET is conducting in the case of a conducting n-conducting field effect transistor n-FET_{LS}. Therewith, p-conducting field effect transistor p-FET conducts and blocks synchronously with the additional n-conductive field effect transistor FET_{LS}. It is, thus, controllable by the control voltage Uₛₜ₁.

The control voltages Uₛₜ₁ and Uₛₜ₂ are established in such a manner that alternately one of the two field effect transistors p-FET or n-FET is switched to conduct, while the other n-FET or p-FET is switched to block.

FIG. 3 shows the time curves of the two control voltages Uₛₜ₁ and Uₛₜ₂. Both control voltages Uₛₜ₁, Uₛₜ₂ are rectangular, alternating voltages, which alternately have a minimum voltage level of 0V and a maximal voltage level U_{high}, and are offset by a half period relative to one another. In this way, an alternating voltage having the frequency f of the two clock rates clock1, clock2 is generated; this alternating voltage is available via a tap P2 arranged between the two field effect transistors p-FET and n-FET. In such case, tap P2 lies at the potential of direct voltage U_{DC} while p-conducting field effect transistor p-FET is conducting and n-conducting field effect transistor n-FET is non-conducting. Conversely, tap P2 lies at ground GND when p-conducting field effect transistor p-FET is non-conducting and n-conducting field effect transistor n-FET is conducting.

The frequency f of alternating voltage U_{AC} generated by chopper 11 is preferably purposely set very low. Frequency f is, for example, lower than 100 kHz, preferably even lower than 50 kHz. Frequency f lies therewith far below frequencies usually used for a switching controller for galvanic isolations. The latter typically lie in the range of several hundred kilohertz. These low frequencies f have the advantage that the alternating voltage U_{AC} can be transmitted without problem over very long connecting lines without disturbances being transmitted in such case to other components of the measurement transmitter, units 7, 9 connected thereto or bus lines connected thereto, e.g. via capacitive couplings.

In order to prevent the two field effect transistors p-FET and n-FET from conducting for a short time during the reversal phases, a short dead time Δt₁₂, Δt₂₁ is provided between each individual switching procedure; both field effect transistors p-FET and n-FET are non-conducting during the dead times Δt₁₂, Δt₂₁. This happens by setting the two control voltages Uₛₜ₁ and Uₛₜ₂ to the low voltage level, here 0V, during the dead times Δt₁₂, Δt₂₁. In this way, a short circuit via the first transverse branch Q1 is prevented.

In determining the dead times Δt₁₂, Δt₂₁, various switching related, signal delay times are preferably taken into consideration. These arise, for example, from level shifter 13, which can have different signal delay times for low high and high low edges for p conductive field effect transistor p-FET. In this case, it is advisable to work with two different dead times Δt₁₂, Δt₂₁ instead of a single dead time Δt; the dead time Δt₁₂ is applicable for the high low transition of the first clocking rate clock1 and the other dead time Δt₂₁ is applicable for the high low transition of the second clocking rate clock2. The two dead times Δt₁₂, Δt₂₁ differ from each other by a time difference given by the different signal delay times in level shifter 13.

During dead time Δt, both field effect transistors p-FET and n-FET are non-conducting. In this way, an undefined voltage level arises on tap P2. In order to prevent the formation of uncontrolled flyback voltages due to switching inherent, parasitic inductances, a third transverse branch Q3 is provided, preferably downstream from the first transverse branch Q1; two diodes Z1, Z2, connected in series and operated in the reverse direction, are arranged in the third transverse branch Q3. Additionally, tap P2 in the first transverse branch Q1 is connected to a tap P3 located between the two diodes Z1, Z2 in the third transverse branch Q3. Flyback voltages, which occur in the case of turning off the p-conductive field effect transistor p-FET connected to the direct voltage U_{DC}, are now led away in the form of an electrical current flowing counter to the reverse direction of diode Z1 while n-conducting field effect transistor n-FET connected to ground is still turned off.

Conversely, flyback voltages, which occur in the case of closing n-conductive field effect transistor n-FET connected to ground GND, are led away in the form of an electrical current flowing counter to the reverse direction of diode Z2 while p-conducting field effect transistor p-FET connected to the direct voltage U_{DC} is still turned off.

Due to the rectangular activating of the field effect transistors p-FET, n-FET, FET_{ES} very fast switching events are executed in chopper 11; these switching events can result in very high frequency disturbance signals, e.g. disturbance signals with frequencies of 50 MHz or more under certain conditions. In order to prevent these disturbance signals from reaching outside, chopper 11 includes, preferably on the input side and on the output side, disturbance suppression circuits 15, 17, which bleed away high frequency current fractions produced, in given cases, by the switching events.

The input side, disturbance suppression circuit 15 includes, for example, an inductance I1 applied in first line L1; inductance I1 is downstream from the transverse branch Q4 equipped with a capacitor C1; furthermore, inductance I1 is upstream from a transverse branch Q5 likewise equipped with a capacitor C2. In this way a filter is formed to attenuate high frequency current fractions, especially current fractions having frequencies in the megahertz range, but allow direct current fractions to pass unimpeded.

Chopper 11 includes a first and a second output line A1 and A2 on the output side. The first output line A1 is connected to tap P3 via an additional tapping P4 arranged between the two diodes Z1, Z2 in the third transverse branch Q3. The second output line A2 is connected to second line L2 and lies therewith at ground GND.

The disturbance suppression circuit 17 provided on the output side is applied, for example, to output lines A1, A2, and includes an inductance I2 in the first output line A1; a transverse branch Q6, which is equipped with a capacitor C1 and connects both output lines A1, A2, is connected downstream from inductance I2. This disturbance suppression circuit 17 also forms a filter, which attenuates high frequency current fractions, especially current fractions having frequencies in the megahertz range, but allows clearly low frequency, alternating current fractions of alternating voltage U_{AC} generated by chopper 11 to pass unimpeded.

Preferably, chopper 11 includes a direct voltage decoupling, which eliminates a direct voltage part present in the produced alternating voltage, on its output side. This is, for example, a direct voltage decoupling capacitor C_{DC} applied to first output line A1. Therewith the alternating voltage U_{AC} shown in FIG. 4 is available at the output of chopper 11, cleaned of the direct voltage part.

The measurement transmitter includes two or more connector modules 19, 21 connected in parallel to chopper 11; connector modules 19, 21 are fed with the rectangular, alternating voltage U_{AC} in parallel by chopper 11. Each connector module 19, 21 includes a transformer 23 and a rectifier 25 downstream from each transformer 23. FIG. 5 shows an example of an embodiment of this, in which two transformers 23 are presented, which are connected in parallel and fed with alternating voltage U_{AC}, with rectifiers 25 downstream. In this case, rectifiers 25 are composed each of four diodes D1, D2, D3, D4, which are connected as a classic bridge rectifier, which preferably is connected to a downstream smoothing capacitor C_{S}.

In such case, the direct voltage decoupling described earlier in chopper 11 offers the advantage that the primary windings of transformers 23 are not unnecessarily loaded by direct current fractions, which would otherwise lead to an undesired heat buildup in transformers 23.

Since a rectangular, alternating voltage U_{AC}, which has precise stabilized voltage levels, here +/−6V, and is generated by chopper 11, and lies on the primary sides of transformers 23, a rectangular secondary voltage with precise stabilized voltage levels is likewise available on their secondary sides. In such case, the rectangular shape of the secondary voltage offers the advantage that a largely constant direct voltage U_{DC1}, U_{DC2} can be produced directly therefrom with a simple rectification. This would not be the case with the application of sinusoidal alternating voltages. Correspondingly, it suffices here to use very small smoothing capacitors CS, such as e.g. cost effective, ceramic capacitors.

A further advantage is that the voltage levels of direct voltages U_{DC1}, U_{DC2} available on the output of rectifiers 25 are freely adjustable via the transformation ratio of each transformer 23.

One of units 7, 9 described above is connectable to each connector module 19, 21. Each unit is then supplied with direct voltage U_{DC1}, U_{DC2} produced by the respective connector module 19, 21; each unit is galvanically isolated from all other components of the measurement transmitter by connector module 19, 21. In such case, units 7, 9 requiring very different direct voltages for their supply can be connected through a corresponding selection of transformers 23.

In parallel thereto, in given cases, a required digital communication between units 7, 9 and digital unit 5 occurs via a digital data line 29, 31, which is equipped with a galvanic isolation 27, e.g. an optocoupler or a transformer; digital data line 29, 31 connects the particular unit 7, 9 to digital unit 5. Here, galvanic isolations 27 are preferably accommodated in the respective connector modules 19, 21.
1 power supply
3 direct voltage generator
5 digital unit
7 unit
9 unit
11 chopper
13 level shifter
15 input side disturbance suppression circuit
17 output side disturbance suppression circuit
19 connector module
21 connector module
23 transformer
25 rectifier
27 galvanic isolation
29 data line
31 data line

1-13. (canceled)

14. A measurement transmitter, comprising:
a power supply, which has a direct voltage generator, which serves to produce a stable direct voltage;
a chopper connected to the direct voltage generator, which produces a rectangular, alternating voltage from the stable direct voltage;
a digital unit, which serves to operate said chopper; and
two or more connector modules connected, in parallel with one another, to said chopper, wherein:
each of said connector modules has a transformer, which transforms the rectangular, alternating voltage,
each of said connector module has a rectifier downstream from said respective transformer; said rectifier produces a direct voltage from the transformed rectangular alternating voltage; and
a connectable unit connectable to each of said connector module; and
each connectable unit is supplied, galvanically isolated from all other components of the measurement transmitter, with direct voltage via its connector module.

15. The measurement transmitter as claimed in claim 14, wherein:
said connectable units are sensors, electrical current outputs of the measurement transmitter, and/or communication units for connecting the measurement transmitter to a superordinated unit.

16. The measurement transmitter as claimed in claim 14, wherein:
at least one of said connectable units is connected to said digital unit via a digital data line equipped with galvanic isolation.

17. The measurement transmitter as claimed in claim 16, wherein:
said galvanic isolation, is arranged in said connector module, to which said connectable unit is to be connected.

18. The measurement transmitter as claimed in claim 16, wherein:
said galvanic isolation is an optocoupler or a transformer.

19. The measurement transmitter as claimed in claim 14, wherein:
said chopper has a p-conductive field effect transistor connected to the direct voltage generated by said voltage generator and, in series with said p-conductive field effect transistor, an n-conductive field effect transistor connected to ground;
said two field effect transistors are operated by control voltages of predetermined clock rates supplied via their control inputs in such a manner that, at a frequency predetermined by the clock rates, one of the two field effect transistors is alternately switched to conduct, while the other field effect transistor blocks; and
a rectangular, alternating voltage is removable via a tap arranged between the two field effect transistors.

20. The measurement transmitter as claimed in claim 19, wherein:
said digital unit produces a first and a second, rectangular control voltage varying with a predetermined clock rate;
the two rectangular control voltages are offset in time by a half period relative to one another;
said chopper includes a level shifter, which, based on the first control voltage, produces a rectangular control voltage with higher voltage levels and varying synchronously with the first control voltage; wherein this rectangular control voltage with higher voltage levels is applied to the control input of said p-conductive field effect transistor and controls said p-conducting field effect transistor; and
the second control voltage lies on the control input of said n-conductive field effect transistor and said n-conducting field effect transistor is controlled via said second control voltage.

21. The measurement transmitter as claimed in claim 19, wherein:
a dead time, during which said two field effect transistors are non-conductive, is provided between the individual switching procedures of said field effect transistors.

22. The measurement transmitter as claimed in claim 21, wherein:
said chopper has two diodes connected in series and operated in reverse bias, said two diodes are arranged parallel to said two field effect transistors and are located downstream from such;
the tap between said two field effect transistors is connected to a tap arranged between said two diodes; and
a rectangular, alternating voltage is removable via said tap arranged between said two diodes.

23. The measurement transmitter as claimed in claim 19, wherein:
said chopper has a disturbance suppression circuit on its input side and/or output side; said disturbance suppression circuit attenuates high frequency current fractions, especially current fractions with frequencies in the megahertz range, caused by switching events of said field effect transistors in said chopper.

24. The measurement transmitter as claimed in claim 14, wherein:
said chopper has a direct voltage decoupling on its output side; the direct voltage decoupling eliminates a direct voltage fraction contained in the alternating voltage generated in said chopper.

25. The measurement transmitter as claimed in claim 14, wherein:
the alternating voltage produced by said chopper has a frequency of less than 100 kHz, especially less than 50 kHz.

26. The measurement transmitter as claimed in claim 14, wherein:
said rectifier is a bridge rectifier with a smoothing capacitor connected downstream.
